(19) United States
(12) Patent Application Publication
(10) Pub. No.: US 2016/0307435 A1
(43) Pub. Date: Oct. 20, 2016

(54) Home invasion - medical alert - theft deterrent device

(71) Applicant: Gabriel G. Lee, Philadelphia, PA (US)

(72) Inventor: Gabriel G. Lee, Philadelphia, PA (US)

(21) Appl. No.: 14/545,291

(22) Filed: Apr. 20, 2015

(51) Int. Cl. G08B 25/01

(52) U.S. Cl. CPC G08B 25/016

(57) ABSTRACT

An alarm protection device having multiple features to monitor, call for help, and provide sound with flashing lights with combination code and LED display. A portable home alarm system is housed in a small compacted design. This device can be used in any room of your home offering many features of operation. It starts by a push button on switch which allows setting up its activation by the user in how the owner wants the device to work for them in their home. The device has a combination setting which can be disarmed by the operator. The device can display on the LED screen your name and location by address and help. With its loud siren of sound it should attract others even if they are not in your house.

This Home invasion—Medical Alert—Theft Deterrent is strong enough to be thrown outside and with its heavy front tip that forces the device to land on its tip to compress the pin activation to alert neighbors by demanding outside attention. This device can call for help once it has detected a violation within the settings by the operator of the device. This alarm protection device has a digital communicator that sends out a call to emergency dispatch for help. It can also call to a preset phone number or call an alarm monitoring company. This device also has a global positioning system for personal tracking of the owner.

### BACKGROUND OF DISCLOSURE

This disclosure relates to safety for anyone who wants to have a potable multifunction alarm that can be programmed by the user in a way that accommodates portable security. This device can be used in your home or carried with you.

### SUMMARY OF THE DISCLOSURE

An alarm protection device having multiple features to monitor, call for help, and provide loud sound with flashing lights and LED screen display. A portable home alarm system is housed in a small compacted design. This device can be used in any room of your home offering many features of operation. It starts by a push button on switch which allows setting up its activation by the user and how the owner wants the device to work for them in their home. The device has a combination setting which can be disarmed by the operator. The device can display on the LED screen your name and location by address and help. With its loud siren of sound it should attract others even if they are not in your house. This Home invasion—Medical Alert—Theft Deterrent is strong enough to be thrown outside and with its heavy front tip that forces the device to land on its tip to compress the pin activation to alert neighbors by demanding outside attention. This device can call for help once it has detected a violation within the settings by the operator of the device. This alarm protection device has a digital communicator that sends out a call to emergency dispatch for help. It can also call to a preset phone number or call an alarm monitoring company. This device also has a global positioning system for personal tracking of the owner. The device was designed with the thought of having a personal alarming system that can be activated by the owner wherever they might be as long as it is with them to activate.

### BRIEF DESCRIPTION OF THE DRAWING

The disclosure will be better understood and objects other that those set forth above will become apparent when consideration is given to the following detailed description of the preferred embodiments.

FIG. 1 illustrates a Block Diagram of an embodiment of the disclosure.

FIG. 2 illustrates an Isometric view of an embodiment of the disclosure.

FIG. 3 illustrates a Front view of an embodiment of the disclosure.

FIG. 4 illustrates a Back view of an embodiment of the disclosure.

FIG. 5 illustrates a Front view of an embodiment of the disclosure.

FIG. 6 illustrates a Back view in an opened position of an embodiment of the disclosure.

### DESCRIPTION OF THE PREFERRED EMBODIMENT

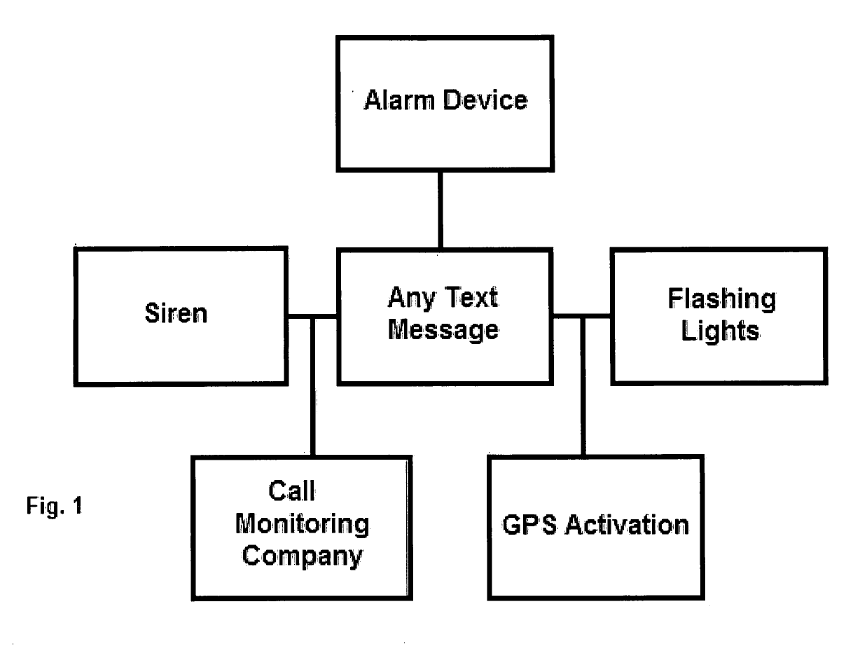

With reference now to the drawings, and in particular to FIGS. 1 through 6 thereof the Home Invasion—Medical Alert—Theft Deterrent Device having a portable alarm design embodying the principles and concepts of an embodiment of the disclosure and generally designated by references 1 through 6.

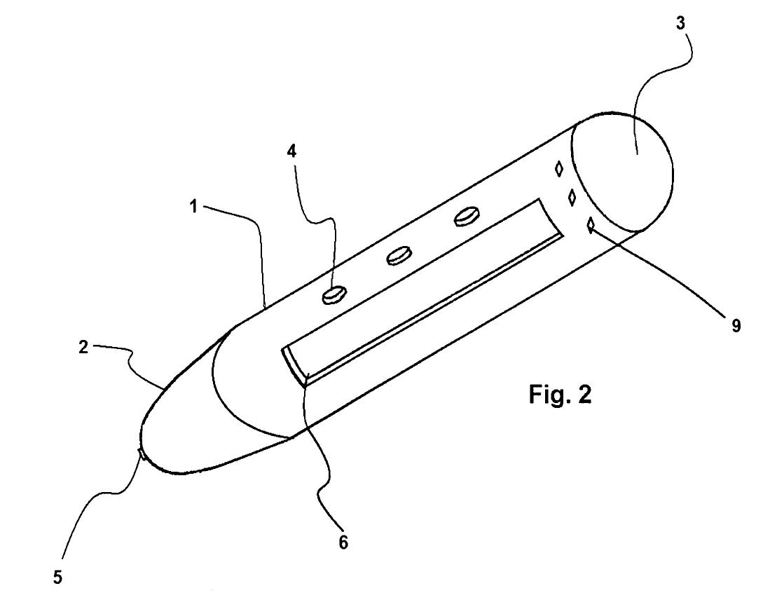

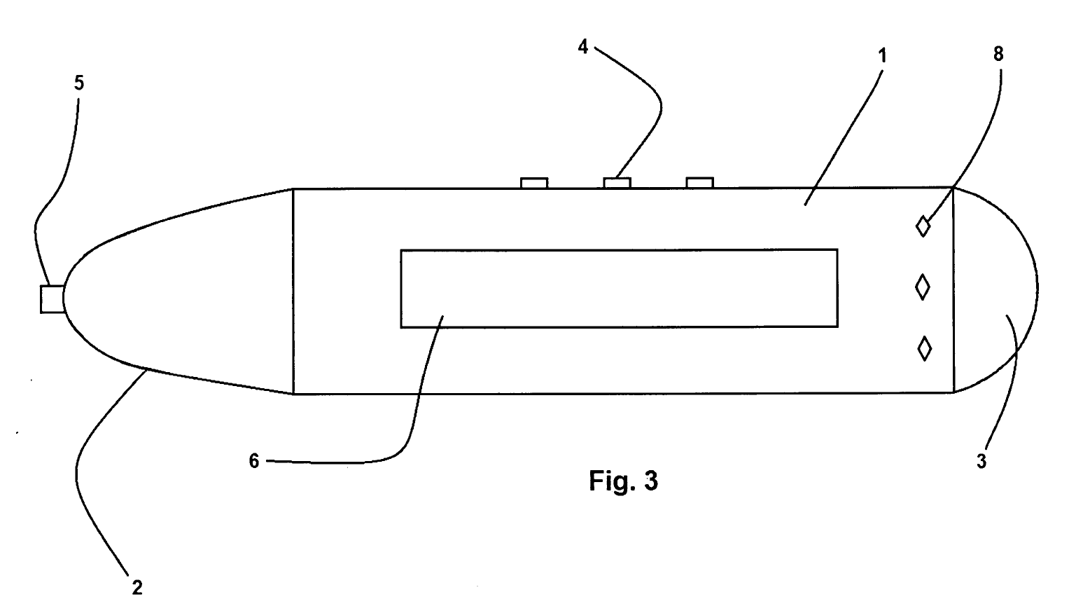

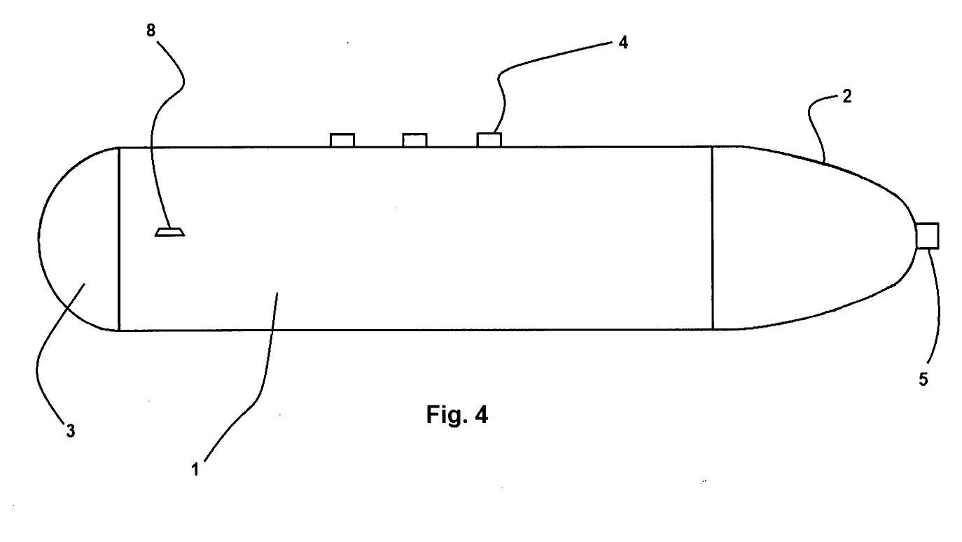

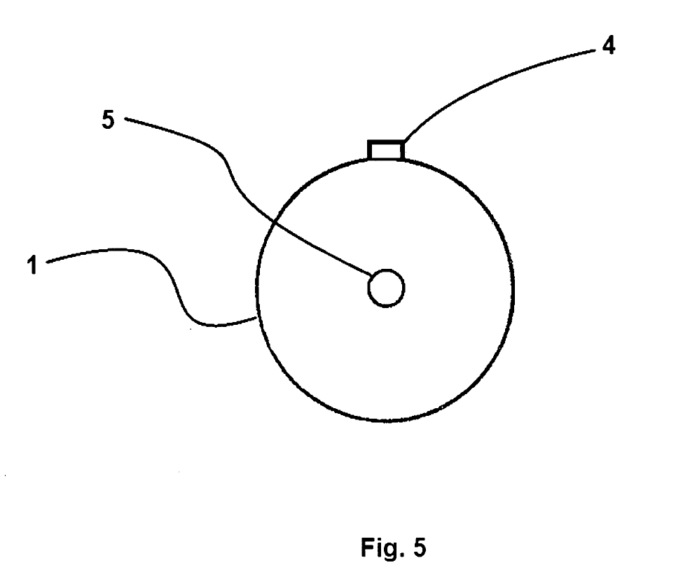

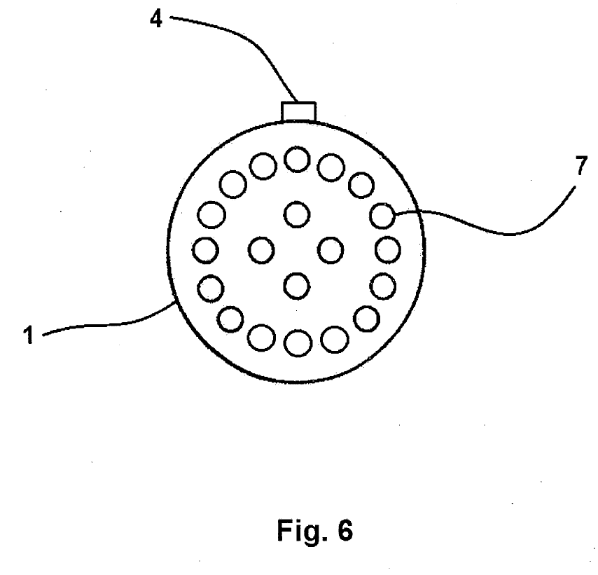

FIG. 1 is a Schematic Diagram of the multiple features of operation the device has to offer the operator and the diagram also makes it easier to view the overall ability of the Home Invasion—Medical Alert—Theft Deterrent Device. The invention has a tubular shell as shown in FIG. 2 is the Isometric View and in FIG. 2 item 1 is designed to support the multiple parts in the alarming device designed features. FIG. 2 item 1 is also called the body tube of the device and its size makes it very portable for the user. FIG. 2 item 2 is the front tip of the device and it was designed with being the heaviest part of the device to control the direction of the device if the user was to toss it so it would land on its tip item 5 and this would activate the Theft Deterrent Device into one of the alarming functions programed by the user. FIG. 2 item 2 is solid inside with a cylinder throughout the center for the housing of the reaction pin item 5 to move through the device when pushed to an inward position to alarm any of the functions programed by the user. FIG. 2 item 3 is a domed light lens housing which help protect the 24 diode lights inside the dome lens 3. The diode lights in FIG. 6 item 7 are bright and flash during the device demanding attention to it. The diode lights 7 can flash to gain attention or show a sign of operation. The lights are designed to work in all functions of the monitoring or alarming device. FIG. 2 Item 4 are 3 function buttons in which these three buttons are used to operate and control any and all of the features designed to make this device a Home Invasion—Medical Alert—Theft Deterrent Device. The function buttons item 4 are housed and supported inside the body tube item 1 and they work by pressing down with your finger to command the device to arm itself to one of the functions of the operator's settings. FIG. 2 item 5 is the reaction button the button is designed to activate if the operator has to throw the device for whatever the reason might be in an emergency situation such as being attacked or having a fire etc. The device will land on its front item 2 and the reaction button item 5 will press inward to activation in multiple alerts all at once. FIG. 2 item 6 is message screen and it was designed to this invention to help the user or owner of the device program messages to appear on the screen when in need of emergency or help from anyone the message screen item 6 can digitally read out any program message inserted by the operator when setting up the device. In FIG. 2 item 9 are three small cut outs into the Body of item 1 which are designed with micro loudspeakers inside similar to the speaker used in the Android phone system. FIG. 3 is the Front View (Side) this view is used to show the all on the same features and item numbers as FIG. 2 but looking directly at the message screen as the operator would do if programing the device. FIG. 4 item 8 in the device is a micro connecting plug. This is a female plug which considered to be the industry standard in the connection of powering and charging the device to strength from a USB or AC adaptor interfaced. By having the micro connection item 8 the operator can connect to a computer to receive updates and data to keep the Home Invasion—Medical Alert—Theft Deterrent Device current with changes. FIG. 5 is called the front view of the device and in this view only the Body item 1, the first Function button item 4 and the Reaction button item 5 are show in this view. These items 1, 4 and 5 were previously explained earlier in this DESCRIPTION OF THE PREFERRED EMBODIMENT. FIG. 6 is the Rear View of the device items 1, and 4 were previously explained earlier in this DESCRIPTION OF THE PREFERRED EMBODIMENT. FIG. 6 item 7 in this Rear View show (20) Red light—emitting diodes (LED) which is a two-lead semiconductor light source which emits a flashing bright light when activated to alarm a violation of one of the setting designated by the operator of the device. The (LEDs) are housed inside item 3 is a domed lens housing which help protect the 24 diode lights inside the dome lens. Item 8 in FIG. 4 is a female micro connecting plug which connect to a male micro connecting plug and it has a Universal Serial Bus Connector (USB) on the other end. The female micro connecting plug item 8 offers many different types of use in connection with the operation of the Home Invasion—Medical Alert—Theft Deterrent Device and management of the system. FIG. 3 item 9 is 3 cut outs that were designed for the micro loudspeakers similar to the speaker used in Android phones and alike. The micro loudspeaker will make a variety sounds to alert the operator of the device or anyone nearby to get attention.

1. A Portable alarm for use of Home, Medical and Theft Detection.

2. The Body item 1 of the device was invented of my own concept.

3. The Front Tip item 2 of the device was invented of my own concept.

4. The Reaction Pin item 5 of the device was invented of my own concept.

5. All other parts in conjunction with this device for full operation of features are all of my own design and concept.
